(19) United States
(12) Patent Application Publication
(10) Pub. No.: US 2009/0232942 A1
(43) Pub. Date: Sep. 17, 2009

(54) Yeast Preparations With Improved Antioxidant Properties and Uses Thereof

(76) Inventors: Richard Degre, ST. BRUNO DE MONTARVILLE (CA); Matthleu Baulez, Tournefeuille (FR); Zhigen Zhang, Montreal (CA); Wardrop Forbes, Pointe-Claire (CA)

Correspondence Address: YOUNG & THOMPSON, 209 Madison Street, Suite 500, ALEXANDRIA, VA, 22314, US

(21) Appl. No.: 11/887,552

(22) PCT Filed: Mar. 30, 2006
(86) PCT No.: PCT/FR2006/000693

§ 371 Date: Dec. 7, 2007

(30) Foreign Application Priority Data
Mar. 30, 2005 (FR) 0503086

(51) Int. Cl. A23L 1/28

(52) U.S. Cl. 426/62

(57) ABSTRACT

The invention concerns yeast preparations having improved antioxidant properties, characterized in that they comprises yeasts concurrently enriched in glutathione and selenium, by at least 15 mg/g of dry matter and selenium by at least 500 ppm advantageously of the order of 2000 ppm. The invention is applicable as antioxidant additives, in particular as foods or nutrients, or functional foods for humans and animals and in cosmetics.

The subject of the invention is yeast preparations that have improved antioxidant properties and their applications as antioxidant additives.

It is known that yeasts rich in selenium, that is to say containing more than about 500 ppm of selenium, and advantageously around 2000 ppm of selenium, are routinely used as dietary supplements in human and animal nutrition.

Within the context of their research into ways of improving the antioxidant properties of such yeasts, the inventors have studied the effects of adding various forms of selenium and/or of glutathione to the yeasts. They have thus observed that, unexpectedly, the antioxidant properties of yeasts could be greatly improved by enrichment with selenium and with glutathione produced in the course of fermentation by the yeasts, or added after fermentation.

The object of the invention is therefore to supply yeast preparations provided with improved antioxidant properties.

The invention also targets their applications as antioxidant additives, in particular as dietary supplements in human nutrition and as additives for animal feeding.

The yeast preparations of the invention, having improved antioxidant properties, are characterized in that they contain yeasts enriched concomitantly with glutathione and with selenium.

This is because it has appeared that the concomitant presence of glutathione and of selenium in a yeast resulted, unexpectedly, in a synergetic effect and made it possible to obtain antioxidant properties greater than those observed with other methods of adding glutathione and selenium.

The expression “yeast enriched with glutathione and with selenium” is understood to mean a yeast containing at least 15 mg of glutathione per gram of dry matter and at least 500 ppm of selenium.

Preferably, said yeasts are yeasts of the Saccharomyces genus and especially of the cerevisiae species.

They are especially breadmaking yeasts.

The methods for producing yeast enriched with selenium are well known to a person skilled in the art (see, in particular, U.S. Pat. No. 4,530,846). The methods for producing glutathione yeast are also widely described (see, in particular, JP 52156994 and JP 61132282). Yeasts enriched concomitantly with selenium and glutathione may be obtained by combining the two types of known methods.

Considering their properties, the yeast preparations defined above have a great advantage, generally, as antioxidant additives.

The invention targets, in particular, their use as dietary supplements for humans or animals, and also the foods or nutrients or functional foods that contain them.

Mention will be made, amongst others, of biscuits and bread enriched by these preparations, or else of dairy products such as yoghurts and also foods for animals.

The preparations of the invention are also advantageous in the cosmetics field, by conferring anti-aging properties on the cosmetic compositions, or as active principles of medications for preventing or treating pathologies associated with the formation of excess free radicals.

In these various applications, the preparations of the invention are especially used in the form of powders or else lyophilizates. Generally, they are present in forms that can be incorporated into food, pharmaceutical (tablets, gel capsules, etc.) or cosmetic (creams, ointments, etc.) preparations.

For applications in human nutrition, doses of 75 to 100 μg/d of Se are advantageously used. In animal nutrition, maximum concentrations of 0.5 ppm of total Se in the complete feed appear suitable. These uses may be of long duration.

The invention also targets a process for obtaining yeast preparations as defined above, characterized by the use of yeasts containing about 15 mg of glutathione/g of dry matter and containing traces of selenium, and of yeasts containing about at least 500 ppm of selenium, advantageously of around 2000 ppm of selenium. Advantageously, yeasts are used that contain, at the same time, about 15 mg of glutathione/g of dry matter and at least about 500 ppm, advantageously around 2000 ppm, of selenium.

Other features and advantages of the invention are given in the following examples.

### EXAMPLE 1

### Comparative Study of the Antioxidant Properties of Yeast Samples

Reported first are the results relating to the antioxidant properties of samples studied measured according to the following 3 methods:
the FOLIN method: this method makes it possible to measure, by colorimetry, the antioxidant power of many types of antioxidants likely to be contained in the various samples. These antioxidants may be easily oxidizable amino acids (tryptophan, tyrosine), selenium compounds, and glutathione. This method is relatively old, but is still commonly used for measuring the antioxidant effects in food products and drinks [Methods of Enzymology, Vol. 335, p. 103-114 (2002)];
the FRAP method: the FRAP (Ferric Reducing Antioxidant Power) method developed by Benzie (Anal. Biochem. 1996 Jul. 15, 239(1):70-6) is also widely recognized for measurements of antioxidant power. This more selective method uses a different standard than that used by the FOLIN method (tocopherol). Therefore, the values obtained by FRAP are lower than those obtained by FOLIN; and
the LAG-TIME/bound LAG-TIME method.

Measurement of the oxidation of low density lipoproteins (abbreviated to LDL) makes it possible to compare various antioxidants at the time of cardiovascular diseases (Free Radic. Biol. Med. 2000 June 15, 28(12):1815-26). The standard method was used at physiological pH and temperature [Methods of Enzymology Vol. 335 p. 103-114 (2001)]. It makes it possible to measure the time required for the added antioxidants to oxidize. This corresponds to the moment preceding the rapid lipoprotein oxidation process (lag time) when the absorbance increases significantly. The effect of the antioxidant present is all the stronger when the lag time is long (in seconds). The kinetic analysis was carried out at 234 nm. The various samples were brought to the same concentration of 1 μm.

Reported hereinafter are the results obtained with the 9 yeast samples from table 1 below:

TABLE 1
Description of the samples

| Sample | | Se (ppm) | | GSH (mg/g) | |
|---|---|---|---|---|---|
| No. | Name | Inorganic | Organic | Inorganic | Organic |
| 1 | LBI 2133 | 0 | 0 | N | N |
| 2 | LBI 2133 | 2000 | 0 | N | N |
| 3 | LBI 2133 | 0 | 0 | Y | N |
| 4 | LBI 2133 | 2000 | 0 | Y | N |
| 5 | Lalmin Se-2000 | 0 | 2000 | N | N |
| 6 | Lalmin Se-2000 | 0 | 2000 | Y | N |
| 7 | Lalmin Antiox | 0 | 2000 | N | Y |
| 8 | FSR* | 0 | 0 | N | Y |
| 9 | FSR + Se salt | 2000 | 0 | N | Y |

*Fermaid Super Relax

The expression “inorganic selenium” is understood to mean exogenous selenium, in the form of salts, i.e. added to the yeast, whereas the expression “organic selenium” denotes selenium added to the fermentation medium and incorporated by the yeast during the fermentation.

The expression “inorganic GSH” is understood to mean exogenous GSH, i.e. added to the yeast, whereas the expression “organic GSH” denotes endogenous GSH, i.e. produced by the yeast itself during the fermentation.

a—FOLIN Method

Measurements of the phenol concentrations of the various yeast samples gave the results reported in table 2 below.

TABLE 2
Phenol concentration of the various yeast samples

| Sample No. | 1 | 2 | 3 | 4 | 5 | 6 | 7 | 8 | 9 |
|---|---|---|---|---|---|---|---|---|---|
| [Phenol] | 8.44 | 8.27 | 13.87 | 14.29 | 8.40 | 15.12 | 32.27 | 16.36 | 14.54 |
| (μmol/g) | 8.35 | 8.40 | 14.45 | 14.95 | 8.75 | 14.54 | 32.92 | 14.70 | 15.04 |
| | 8.31 | 8.09 | 14.70 | 14.87 | 8.75 | 14.45 | 32.60 | 15.70 | 15.12 |
| Average | 8.37 | 8.25 | 14.34 | 14.70 | 8.63 | 14.70 | 32.60 | 15.59 | 14.90 |
| % STD | 1% | 2% | 3% | 2% | 2% | 2% | 1% | 5% | 2% |

In table 3, the statistical analysis calculations of the phenol concentrations are given where “yes” corresponds to a statistically significant difference between the groups (P=0.05) and “no” corresponds to a difference that is not statistically significant between the groups (P>0.05).

TABLE 3
Statistical analysis of the phenol concentrations

| Sample No. | 1 | 2 | 3 | 4 | 5 | 6 | 7 | 8 |
|---|---|---|---|---|---|---|---|---|
| 2 | No | / | / | / | / | / | / | / |
| 3 | Yes | Yes | / | / | / | / | / | / |
| 4 | Yes | Yes | No | / | / | / | / | / |
| 5 | No | No | Yes | Yes | / | / | / | / |
| 6 | Yes | Yes | No | No | Yes | / | / | / |
| 7 | Yes | Yes | Yes | Yes | Yes | Yes | / | / |
| 8 | Yes | Yes | Yes | No | Yes | No | Yes | / |
| 9 | Yes | Yes | No | No | Yes | No | Yes | No |

“Yes”: statistically significant difference between the groups (P = 0.05).
“No”: no statistically significant difference between the groups (P > 0.05).

The results obtained show that the addition:
of inorganic GSH (1 vs. 3) or organic GSH (1 vs. 8) to a conventional yeast makes it possible to significantly increase the antioxidant power (8.37/14.34/15.59);
of inorganic GSH to a yeast rich in organic Se (5 vs. 6) makes it possible to significantly increase the antioxidant power (8.63 vs. 14.70);
of inorganic GSH to a yeast rich in inorganic Se (2 vs. 4) makes it possible to significantly increase the antioxidant power (8.25 vs. 14.70);
of inorganic Se (1 vs. 2) or organic Se (1 vs. 5) to a conventional yeast does not make it possible to increase the antioxidant power (8.37/8.25/8.63);
of inorganic Se to a yeast rich in organic GSH (8 vs. 9) does not make it possible to increase the antioxidant power (15.59/14.90); and of inorganic Se to a yeast rich in inorganic GSH (3 vs. 4) does not make it possible to increase the antioxidant power (14.34/14.70).

Surprisingly, the simultaneous supply of organic GSH and Se (Lalmin Antiox: sample 7) enables a very significant increase in the antioxidant power vs. the other treatments (32.60).

This sample of Lalmin Antiox yeast (sample 7) has an antioxidant power which is very significantly greater than that of the yeasts subjected to different treatments.

These results show that the simultaneous supply by a same yeast of organic Se and of organic GSH added during fermentation has an obvious advantage for increasing the antioxidant potential.

b—FRAP Method

The results obtained with the various samples are given in Table 4 below.

TABLE 4
FRAP results of the various samples

| Sample No. | 1 | 2 | 3 | 4 | 5 | 6 | 7 | 8 | 9 |
|---|---|---|---|---|---|---|---|---|---|
| FRAP | 3.25 | 3.46 | 3.61 | 3.57 | 3.06 | 4.14 | 7.77 | 4.14 | 4.41 |
| (μmol/g) | 3.46 | 3.42 | 3.42 | 3.48 | 2.96 | 4.14 | 7.70 | 4.58 | 4.54 |
| | 3.29 | 3.46 | 3.65 | 3.67 | 2.89 | 4.35 | 7.62 | 4.31 | 4.33 |
| Average | 3.34 | 3.45 | 3.56 | 3.57 | 2.97 | 4.21 | 7.70 | 4.34 | 4.43 |
| (μmol/g) | 3% | 1% | 3% | 3% | 3% | 3% | 1% | 5% | 2% |
| % STD | | | | | | | | | |

The statistical analysis calculations of the phenol concentrations are given in table 5 below.

TABLE 5
Statistical analysis of the phenol concentrations

| Sample No. | 1 | 2 | 3 | 4 | 5 | 6 | 7 | 8 |
|---|---|---|---|---|---|---|---|---|
| 2 | No | / | / | / | / | / | / | / |
| 3 | No | No | / | / | / | / | / | / |
| 4 | No | No | No | / | / | / | / | / |
| 5 | Yes | Yes | Yes | Yes | / | / | / | / |
| 6 | Yes | Yes | Yes | Yes | Yes | / | / | / |
| 7 | Yes | Yes | Yes | Yes | Yes | Yes | / | / |
| 8 | Yes | Yes | Yes | Yes | Yes | No | Yes | / |
| 9 | Yes | Yes | Yes | Yes | Yes | No | Yes | No |

The entries “yes” and “no” have the meanings given above.

This method again demonstrates that the Lalmin Antiox sample (yeast sample No. 7) has an antioxidant power which is very significantly greater than that of the samples having undergone different treatments. Specifically, it appears that the addition:
of inorganic GSH to a conventional yeast (1 vs. 3) does not make it possible to significantly increase the antioxidant power (3.34/3.56);
of organic GSH to a conventional yeast (1 vs. 8) makes it possible to significantly increase the antioxidant power (3.34/4.34);
of inorganic GSH to a yeast rich in organic Se (5 vs. 6) makes it possible to significantly increase the antioxidant power (2.97 vs. 4.21);
of inorganic GSH to a yeast rich in inorganic Se (2 vs. 4) does not make it possible to significantly increase the antioxidant power (3.45 vs. 3.57);
of inorganic Se (1 vs. 2) or organic Se (1 vs. 5) to a conventional yeast does not make it possible to increase the antioxidant power (3.34/3.45/2.97);
of inorganic Se to a yeast rich in organic GSH (8 vs. 9) does not make it possible to increase the antioxidant power (4.34/4.43); and of inorganic Se to a yeast rich in inorganic GSH (3 vs. 4) does not make it possible to increase the antioxidant power (3.56/3.57).

On the other hand, by combining the supply of organic GSH and Se in the Lalmin Antiox sample (sample 7), the antioxidant power is increased very significantly vs. the other treatments (7.70).

This yeast sample has an antioxidant power which is very significantly greater than that observed by applying other treatments to the yeasts and confirms the advantage of the simultaneous supply by a same yeast of organic Se and of organic GSH added during fermentation, for improving the antioxidant effects of glutathione.

c—LAG-TIME/Bound LAG-TIME Method

### Sample Preparation

1 mM of sample was prepared by mixing 395 mg of base sample with 10 ml of distilled water. The mixture was subjected to Vortex stirring for 5 minutes, then to centrifugation for 10 minutes. 1 mM of supernatant was recovered. This product was ready to use. (sample No. 7 was ground into a fine powder before being mixed with water).

### LDL/VLDL Preparation

This was carried out as described in Methods of Enzymology, Vol. 335, p. 103-114, 2001.

### Materials and Methods

The procedure described in the publication J. Agric. Food Chem. 1995, 43:2798-2799 was used for measuring the oxidation rate of the LDLs alone (control) and of the LDLs to which an antioxidant had been added. This experiment thus made it possible to measure the capacity of the antioxidant tested to inhibit oxidation.

The LDL/VLDL preparation and the various samples were diluted in PBS in order to obtain the desired concentration (70 μg/ml of LDL/VLDL). The control batch contained only the 70 μg/ml LDL/VLDL preparation and PBS. The absorbance of the PBS, the control batch and the other samples was carried out at a wavelength of 234 nm over 10 min on a Genesys 5 machine. Next, 25 μM of Cu²⁺ (final concentration in the solution) were added and mixed and the absorbance measurement was carried out every 5 minutes for 6 to 8 hours. The results obtained are given in table 6 below.

TABLE 6
Inhibition of 1 μM of sample

| | | | | Unbound | |
|---|---|---|---|---|---|
| | | | | seleno- | |
| Sample | | Unbound | Unbound | methionine | Unbound |
| No. | Control | #5 | #7 | (Se-Me) | tocopherol |
| Lag Time | 3035 | 9480 | 25371 | 2805 | 7285 |
| (seconds) | | | | | |

| | | | | |
|---|---|---|---|---|
| Increase of Lag | 212% | 736% | −8% | 140% |
| Time 1 (%) | | | | |

$Increase of Lag Time 1 = \frac{\begin{matrix}( Lag Time of the Sample - \\ Lag Time of the Control )\end{matrix}}{Lag Time of the Control} \times 100$

The statistical analysis calculations of the tocopherol concentrations are given in table 7.

TABLE 7
Statistical analysis of the inhibition of 1 μM of sample

| Sample No. | Control | #5 | #7 | Se-Me | Tocopherol |
|---|---|---|---|---|---|
| #5 | Yes | / | / | / | / |
| #7 | Yes | Yes | / | / | / |
| Se-Me | No | Yes | Yes | / | / |
| Tocopherol | Yes | Yes | Yes | Yes | / |

The entries “yes” and “no” have the meanings given above.

In comparison to the control, the Se-Me sample did not show signs of inhibition at this low concentration. However, the tocopherol and samples 5 & 7 showed high levels of inhibition. These samples have an inhibition that is significantly greater than tocopherol. The antioxidant power of these samples is greater than that of the selenomethionine. The Lalmin Antiox sample 7 has an inhibition significantly greater than that of Sample 5.

### Bound LAG TIME

### Materials and Methods

The LDLs and the various antioxidants were inoculated so that bonds were created. This phenomenon is supposed to represent what happens in the plasma when an antioxidant having the ability to bind is absorbed.

The various samples and the LDL/VLDL preparation were diluted to 1 μM and 70 μg/ml respectively in PBS, then incubated at ambient temperature for 2 hours. Next, 25 μM of Cu²⁺ (final concentration in the solution) were added and mixed and the absorbance measurement was carried out every 5 minutes for 6 to 8 hours. The absorbance of the samples was measured at a wavelength of 234 nm over 10 min on a Genesys 5 machine. The tocopherol was used as a positive control given that it is known for binding to the LDL which is generally a tocopherol carrier in plasma.

The results obtained are given in table 8 below.

TABLE 8
Inhibition of 1 μM of sample

| | | | | Bound | |
|---|---|---|---|---|---|
| Sample | | Bound | Bound | seleno- | Bound |
| No. | Control | #5 | #7 | methionine | tocopherol |
| Lag Time | 3035 | 21867 | / | 6267 | 20940 |
| (seconds) | | | | | |

| | | | | |
|---|---|---|---|---|
| Increase of Lag Time 1 (%) | 620% | / | 106% | 590% |
| Increase of Lag Time 2 (%) | 131% | / | 123% | 187% |

$Increase of Lag Time 1 = \frac{\begin{matrix}( Lag Time of the Sample - \\ Lag Time of the Control )\end{matrix}}{Lag Time of the Control} \times 100$
$Increase of Lag Time 2 = \frac{\begin{matrix}( Lag Time of the Bound Sample - \\ Lag Time of the Unb ound Sample )\end{matrix}}{Lag Time of the Unbound Sample} \times 100$

The results of the statistical analysis of the inhibition of 1 μM of sample are given in table 9 below.

TABLE 9

| | Con- | | | Se- | Toco- | Bound | Bound |
|---|---|---|---|---|---|---|---|
| Sample No. | trol | #5 | #7 | Me | pherol | #5 | Se-Me |
| #5 | Yes | / | / | / | / | / | / |
| #7 | Yes | Yes | / | / | / | / | / |
| Se-Me | No | Yes | Yes | / | / | / | / |
| Tocopherol | Yes | Yes | Yes | Yes | / | / | / |
| Bound #5 | Yes | Yes | Yes | Yes | Yes | / | / |
| Bound Se-Me | Yes | Yes | Yes | Yes | No | Yes | / |
| Bound | Yes | Yes | Yes | Yes | Yes | Yes | Yes |
| tocopherol | | | | | | | |

The entries “yes” and “no” have the meanings given above.

In comparison to the preceding experiment, the LAG TIMEs of all the samples tested have increased by more than 1006 (that of Lalmin Antiox is not shown since >10 hours).

These 2 experiments show that the Lalmin Antiox sample 7 has an antioxidant power much more significant than sample 5. The unbound sample 7 is even greater than the bound sample 5. The bound sample 7 has a LAG TIME of more than 10 hours, i.e. 36,000 seconds, which is 50% above the bound tocopherol and the bound sample 5.

### EXAMPLE 2

### Comparison of the Antioxidant Activity of Samples in UV-Visible Range

Reported below are the results obtained by comparing the antioxidant properties of two samples, including one according to the invention, with respect to their capacity to reduce the 2,2-diphenyl-1-picrylhydrazyl radical (DPPH.) (UV-visible).

2,2-Diphenyl-1-picrylhydrazyl (DPPH.) is a stable organic radical having a characteristic absorption at λ=523 nm in a MeOH/H₂O (2/1) mixture. DPPH. has an intense violet color and this compound remains stable, in the solid form, for years. An antioxidant, proton donor, is capable of reducing this radical (DPPH.→DPPH₂), which leads to a decrease in its absorbance. The antioxidant capacity of the compounds is thus determined by evaluating the percentage of inhibition of the absorbance of DPPH. at 523 nm.

The weight concentration of the extracts decreasing the absorbance of DPPH. at 523 nm by 50% (IC₅₀) is determined using the straight-line equation: absorbance of DPPH. at 523 nm=f(concentration of the mixture tested). The extract having the lowest IC₅₀ value is the extract having the most effective antioxidant capacity.

The DPPH. sold by Aldrich and the vitamin C sold by Merck were used.

The results obtained with the following samples E1 and E2 are given:

E1: Lalmin Antiox—yeast enriched concomitantly with selenium and with glutathione (Se: 2000 ppm; GSH: 20 mg/g).
E2: FSR—yeast enriched with glutathione+LalminSe−yeast enriched with selenium.

In these tests, the selenium and glutathione concentrations were such that the solution of E2 contained as much selenium and glutathione as that of E1. The method used made it possible to evaluate the overall antioxidant power of the mixture and to compare it to that of reference substances under the same experimental conditions. The antioxidant activity was evaluated by measuring the capacity of the extract to trap the DPPH⁻ radical.

The results obtained are given in tables 10 and 11 below:

TABLE 10
IC₅₀ of the reference molecules, glutathione and vitamin C (n = 3)

| | |
|---|---|
| Mean | Standard deviation |

| | |
|---|---|
| Time (min) | IC₅₀ (mg/l) |

| | | |
|---|---|---|
| Glutathione | | |
| 10 | 292.97 | 13.90 |
| 20 | 233.84 | 9.73 |
| 30 | 202.13 | 8.31 |
| Vitamin C | | |
| 10 | 5.24 | 0.27 |
| 20 | 5.20 | 0.25 |
| 30 | 5.16 | 0.30 |

TABLE 11
IC₅₀ of the samples E1 and E2

| | IC₅₀ (mg/l) with respect to the mass |
|---|---|
| Sample | of powder weighed |
| E1 | 1461 |
| E2 | 6944 |

Examining the results obtained shows that:
The antioxidant activity in this test is higher for vitamin C than for glutathione.
The IC₅₀ of the glutathione is equal to 202.13 mg/l, i.e. 40 times higher than that for vitamin C (table 10).
The IC₅₀ of E1 and of E2 are respectively 1461 mg/l and 6944 ml/l, showing the superiority of the antioxidant effect for the yeasts enriched concomitantly with selenium and with glutathione.

### EXAMPLE 3

### Use of the Yeast Preparations in Food

A yeast enriched simultaneously with glutathione and with selenium was used, so as to bring the reducing power of the mixture to more than 15 μmol of phenol/g of powder according to the FOLIN method or to more than 5 μmol/g according to the FRAP test.

The yeast preparation was ground to obtain a powder. The yeast preparation was incorporated in pulvurulent form into a biscuit dough.

1. Yeast preparations, having improved antioxidant properties, characterized in that they comprise yeasts enriched concomitantly with glutathione and with selenium, in an amount of at least 15 mg/g of dry matter and selenium in an amount of at least 500 ppm, advantageously of around 2000 ppm.

2. The yeast preparations as claimed in claim 1, characterized in that said yeasts are yeasts of the Saccharomyces genus and especially of the cerevisiae species.

3. The yeast preparations as claimed in claim 2, characterized in that they are breadmaking yeasts.

4-7. (canceled)
